(19) United States
(12) Patent Application Publication
(10) Pub. No.: US 2015/0022302 A1
(43) Pub. Date: Jan. 22, 2015

(54) METALIZED PLASTIC HEADER APPARATUS AND METHODS OF MANUFACTURE AND USE

(71) Applicant: PULSE ELECTRONICS, INC., San Diego, CA (US)

(72) Inventor: Timothy Craig Wedley, Tuam (IE)

(21) Appl. No.: 14/335,746

(22) Filed: Jul. 18, 2014

Related U.S. Application Data
(60) Provisional application No. 61/856,570, filed on Jul. 19, 2013.

(51) Int. Cl. H01F 27/02; H01F 27/24; H01F 27/29

(52) U.S. Cl. CPC H01F 27/02; H01F 27/292; H01F 27/24
USPC 336/90

(57) ABSTRACT

A low cost and highly consistent metallized header electronic assembly. In one embodiment, a metallized header assembly having electronic circuitry as well as terminals manufactured from an LDS polymer is disclosed. The metallized header assembly also includes electronic component receiving cavities configured to house one or more wire-wound magnetic cores. The wire leads from the wire-wound magnetic cores are electrically coupled to the terminals on the metallized header assembly via a eutectic solder using well known soldering techniques such as hand soldering, solder dipping, resistance welding, and the like. Methods of manufacturing and using the aforementioned metallized header assembly are also disclosed.

### PRIORITY

This application claims the benefit of priority to co-owned U.S. Provisional Patent Application Ser. No. 61/856,570 of the same title filed Jul. 19, 2013, the contents of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

1. Technological Field

The present disclosure relates generally to circuit elements, and more particularly in one exemplary aspect to electronic packaging for these circuit elements, and methods of utilizing and manufacturing the same.

2. Description of Related Technology

A myriad of different configurations of inductive devices are known in the prior art. One common approach to the manufacture of inductive devices is the use of one or more wire-wound magnetically permeable toroidal cores housed within an underlying carrier apparatus. Toroidal cores are often used, as they are very efficient at maintaining the magnetic flux of an inductive device constrained within the core itself thereby improving the magnetic efficiency of the device. Each wound core will typically contain a plurality of wound wires that are in turn connected to conductive terminal pins of the underlying carrier apparatus. Typically, the connection of the core wires to these conductive terminal pins of the carrier apparatus are realized by manually wrapping the core wires around the conductive terminal pins, and then soldering these core wires to the terminal pins. Additionally, printed circuit boards with discrete electronic components attached thereto are sometimes utilized in conjunction with these carrier apparatus and magnetically permeable cores in order to form, inter alia, a Digital Subscriber Line (“DSL”) filter.

For example, U.S. Pat. No. 7,598,839 to Wedley discloses an inductive electronic apparatus that includes an inductive device module comprising N inductors and N+1 core elements. The core elements comprise ferrite core pieces that are optionally identical to one another. These core elements are stacked (e.g., in a longitudinal coaxial arrangement) such that the back of one core element associated with a first inductor provides a magnetic flux path for a second inductor.

Form-less (bonded) windings are also optionally used to simplify the manufacture of the device, reduce its cost, and allow it to be made more compact (or alternatively additional functionality to be disposed therein). One variant utilizes a termination header for mating to a PCB that has one or more electronic components mounted thereon. The ferrite cores and associated windings, in combination with the electronic components mounted on the PCB, form an electronic circuit useful in many applications such as DSL filter applications.

However, the foregoing prior art configurations are not optimized in terms of reducing component count (i.e., the number of constituent components), assembly time, improved co-planarity and size (e.g. height), as well as cost. Accordingly, there is a need for apparatus, systems and methods that reduce material, assembly and/or labor costs while offering reduced overall size. Ideally, such a solution would reduce the overall cost and improve reliability of the underlying circuit by, inter cilia, eliminating the need for a separate PCB and the electronic component terminations associated therewith that are used in conjunction with an underlying carrier apparatus.

### SUMMARY

The aforementioned needs are satisfied herein by providing improved metallized header electronics apparatus, and methods for manufacturing and using the same.

In a first aspect, a metallized header suitable for mounting onto the surface of a printed circuit board is disclosed. In one embodiment, the header apparatus includes electronic circuitry disposed thereon with one or more terminal pins associated with the header. The electronic circuitry is configured to accommodate one or more electronic components.

In a second aspect, a metallized header suitable for through-hole mounting on a printed circuit board is disclosed.

In a third aspect, methods of manufacturing the aforementioned metallized headers are disclosed.

In a fourth aspect, a metallized header electronics apparatus using the aforementioned headers are disclosed. In one embodiment, the metallized header electronics apparatus includes a header assembly having electronic circuitry disposed thereon. One or more inductive devices are housed within the header assembly. One or more terminal pins associated with the header assembly have one or more wire leads from the inductive device(s) attached thereto. The electronic circuitry has one or more electronic components mounted thereto.

In a fifth aspect, methods of manufacturing the aforementioned metallized header electronic apparatus are disclosed.

In a sixth aspect, methods of using the aforementioned metallized headers are disclosed.

In a seventh aspect, methods of using the aforementioned metallized header electronics apparatus are disclosed.

Various objects, features, aspects and advantages of the inventive subject matter will become more apparent from the following detailed description of preferred embodiments, along with the accompanying drawings.

### BRIEF DESCRIPTION OF THE DRAWINGS

The features, objectives, and advantages of the disclosure will become more apparent from the detailed description set forth below when taken in conjunction with the drawings, wherein:

FIG. 1A is a perspective view of the underside of a first exemplary embodiment of a metallized header in accordance with the principles of the present disclosure.

FIG. 1B is a perspective view of the topside of the first exemplary metallized header of FIG. 1A, illustrating the electronic component receiving cavities in accordance with the principles of the present disclosure.

FIG. 2A is a perspective view of the topside of a second exemplary embodiment of a metallized header in accordance with the principles of the present disclosure.

FIG. 2B is a perspective view of the underside of the second exemplary metallized header of FIG. 2A, in accordance with the principles of the present disclosure.

FIG. 3 is a third angle projection view illustrating the front, side and underside of an exemplary embodiment of a metallized header electronics apparatus in accordance with the principles of the present disclosure.

FIG. 4 is logical flow diagram illustrating one exemplary embodiment of a method of manufacturing the metallized header electronics apparatus of FIG. 3, in accordance with the principles of the present disclosure.

Reference is now made to the drawings wherein like numerals refer to like parts throughout.

### DETAILED DESCRIPTION

As used herein, the terms “electrical component” and “electronic component” are used interchangeably and refer to components adapted to provide some electrical and/or signal conditioning function, including without limitation inductive reactors (“choke coils”), transformers, filters, transistors, gapped core toroids, inductors (coupled or otherwise), capacitors, resistors, operational amplifiers, and diodes, whether discrete components or integrated circuits, whether alone or in combination.

As used herein, the term “magnetically permeable” refers without limitation to any number of materials commonly used for forming inductive cores or similar components, including without limitation various formulations made from ferrite.

As used herein, the term “signal conditioning” or “conditioning” shall be understood to include, but not be limited to, signal voltage transformation, filtering, current limiting, sampling, processing, and time delay.

As used herein, the terms “top”, “bottom”, “side”, “up”, “down” and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

### Overview

The present disclosure provides, inter cilia, improved low cost metallized header electronic assemblies and methods for manufacturing, and utilizing, the same.

More specifically, the present disclosure addresses prior art mechanical devices which heretofore necessitated a separate printed circuit board in order to include for example, surface mountable electronic components with the wire leads coming off of a wound transformer.

In one embodiment, a metallized header assembly having electronic circuitry as well as terminals manufactured from a laser direct structuring (LDS) polymer is disclosed. The metallized header assembly also includes electronic component receiving cavities configured to house one or more wire-wound magnetic cores. The wire leads from the wire-wound magnetic cores are electrically coupled to the terminals on the metallized header assembly via a eutectic solder using well known soldering techniques such as hand soldering, solder dipping, etc. Alternatively, the wire leads from the wire-wound magnetic cores can be electrically connected to the terminals using well-known resistance welding techniques.

Methods of manufacturing and using the aforementioned metallized header assembly are also disclosed.

### Exemplary Embodiments

Detailed descriptions of the various embodiments and variants of the apparatus and methods of the present disclosure are now provided. While primarily discussed in the context of inductive devices used in networking applications, the various apparatus and methodologies discussed herein are not so limited. In fact, many of the apparatus and methodologies described herein are useful in the manufacture of any number of electronic or signal conditioning components that can benefit from the metallized apparatus and methods described herein, which may also be useful in different applications, and/or provide different signal conditioning functions.

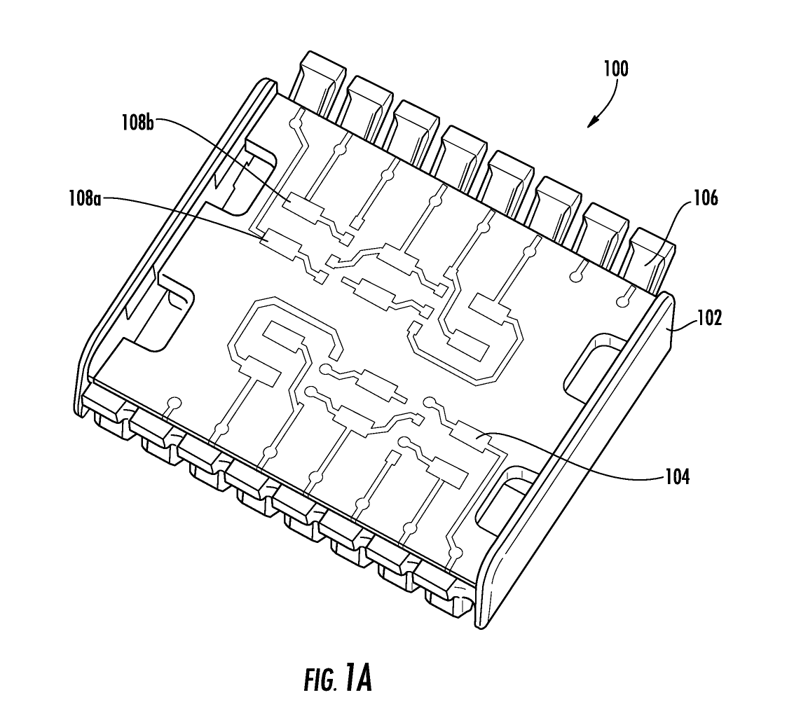

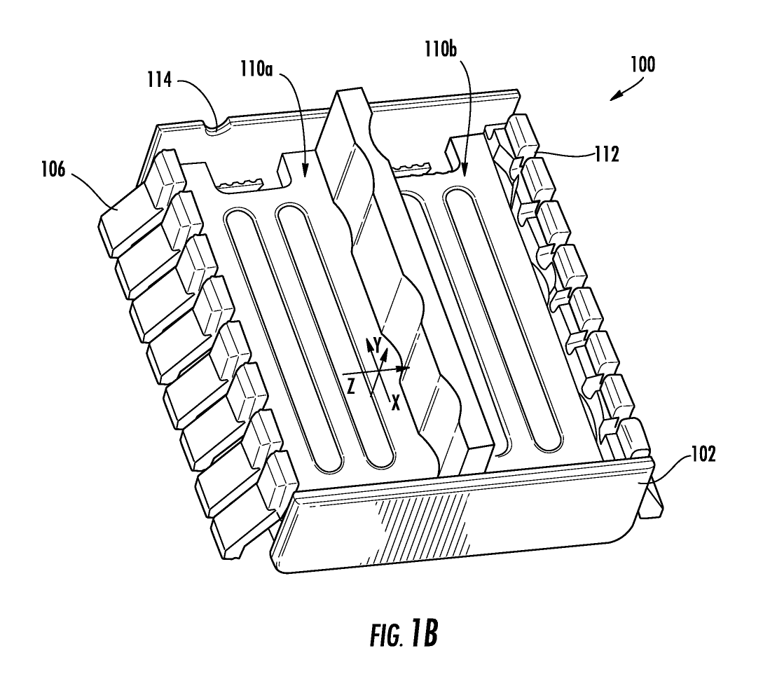

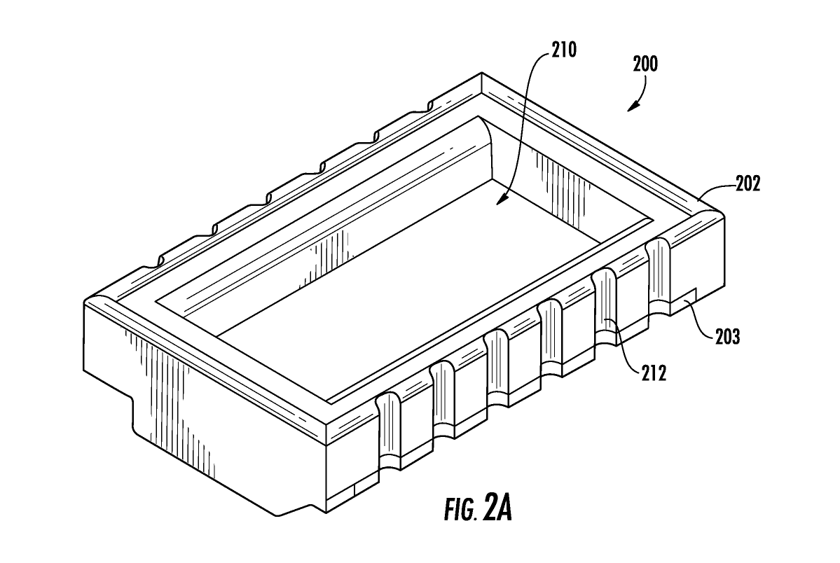

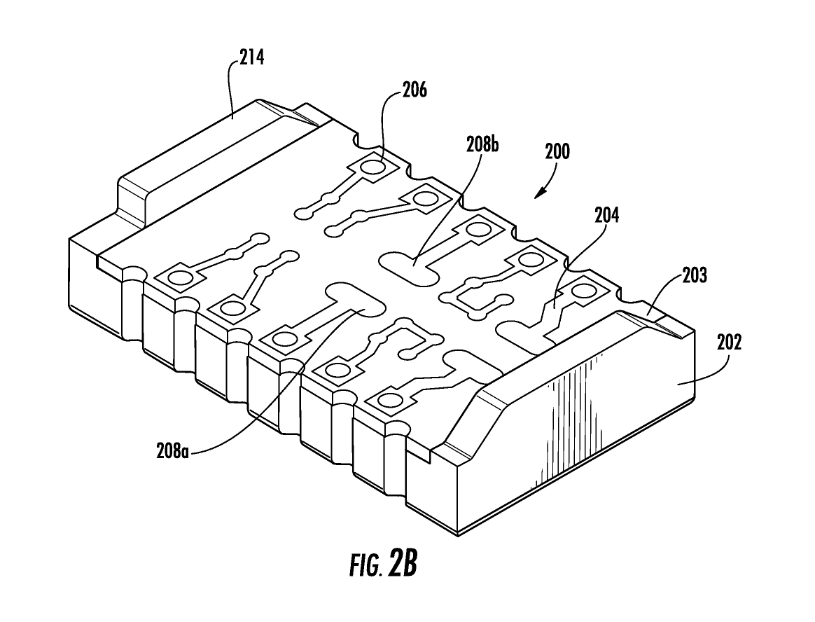

In addition, it is further appreciated that certain features discussed with respect to specific embodiments can, in many instances, be readily adapted for use in one or more other contemplated embodiments that are described herein. For example, the two-piece header assembly described herein with respect to FIGS. 2A and 2B is described for use with through-hole terminations. However, it will be appreciated that the design illustrated with respect to FIGS. 2A-2B could readily be adapted for surface mount terminations, such as those disclosed with respect to FIGS. 1A and 1B. Accordingly, it can be readily recognized by one of ordinary skill, given the present disclosure, that many of the features described herein possess broader usefulness outside of the specific examples and implementations with which they are described, and in fact many features shown with respect to one embodiment can be combined with or used in place of those associated with other embodiments.

### Metallized Header Apparatus

FIG. 1A illustrates the underside of a first exemplary metallized header 100 manufactured in accordance with the principles of the present disclosure. The metallized header of FIG. 1A is formed from an injection molded polymer material 102. In one exemplary embodiment, the polymer material is a thermoplastic material that is doped with a metal-plastic additive which is configured to be activated via the use of a laser. Such a manufacturing process is known as laser direct structuring (“LDS”). After formation of the header using well-known injection molding techniques, the electronic circuitry 104, as well as the terminations 106 for the header apparatus, is activated by means of a laser. The application of the electronic circuitry, as well as the terminations, is exemplary in that there are very little geometric restrictions for such a header design. As there are very few geometric restrictions, the underlying electronic circuitry can be located virtually anywhere on the three-dimensional surface of the metallized header 102.

The illustrated electronic circuitry 104 is formed (“activated”) when the laser beam hits the metal additive present within the LDS polymer. The metal particles activated during this process form the nuclei for subsequent metallization processing steps. In one exemplary embodiment, this activated LDS polymer is submerged within an electroless copper bath. This electroless copper bath results in copper being deposited along the areas where the LDS polymer was activated via the laser. After being placed in the electroless copper bath, additional layers of, for example, copper, nickel and/or gold can be deposited onto these activated copper areas.

In an alternative embodiment, the electronic circuitry 104 is deposited onto the surface of the header 102 using a conductive fluid deposition technique, such as that described in co-owned and co-pending U.S. patent application Ser. No. 13/782,993 filed Mar. 1, 2013 and entitled “Deposition Antenna Apparatus and Methods”, the contents of which are incorporated herein by reference in their entirety. The exemplary techniques described therein allow for, inter alia, deposition of a flowable (e.g., fluid) conductive ink or other substance using e.g., pneumatic or other printing apparatus, and subsequent curing via heat, radiation, chemical action, and/or other approaches.

As is illustrated in FIG. 1A, the exemplary implementation of the electronic circuitry 104 consists of six (6) pairs of termination pads 108a, 108b such that they become mounting locations for surface mountable electronic components such as chip resistors, chip capacitors, chip inductors, etc. For example, these mounting locations can accommodate the surface mountable chip choke apparatus disclosed in co-owned and co-pending U.S. patent application Ser. No. 13/835,217 filed Mar. 15, 2013, the contents of which are incorporated herein by reference in their entirety. While a specific electronic circuitry topography is shown in FIG. 1A, any number of different electronic circuitry topographies can be readily substituted to accommodate any number of differing surface mountable and/or through-hole electronic components or even electronic components (e.g. trace inductors or capacitors) manufactured from the deposited layers of conductive material itself These and other variations would be readily apparent to one of ordinary skill given the present disclosure.

Referring now to FIG. 1B, the top side of the metallized header 100 illustrated in FIG. 1A is shown and described in detail. In the illustrated embodiment, two (2) electronic component receiving cavities 110a, 110b are integrally molded within the body of the injection molded header 102. These cavities 110a, 110b are sized so as to accommodate a plurality of wound inductive devices. In one embodiment, a plurality of inductive devices comprised of windings and core elements, such as those disclosed in co-owned U.S. Pat. No. 7,598,839 to Wedley entitled “Stacked Inductive Device and Methods of Manufacturing”, the contents of which are incorporated herein by reference in its entirety, can readily be accommodated within these electronic component receiving cavities. The windings from these inductive devices are routed from their respective cavity through a wire routing slot 112 and wrapped around a respective termination 106. The metallized header 100 also includes an orientation notch 114 in the header that is indicative of where a specified pin location (e.g. pin one (1)) for subsequent mounting to a printed circuit board.

Referring now to FIG. 2A, a second exemplary embodiment of a metallized header 200 manufactured in accordance with the principles of the present disclosure is shown. The metallized header of FIG. 2A is, unlike the embodiment illustrated in FIGS. 1A and 1B, formed from two (2) different injection molded polymer materials 202, 203. The first portion 202 of the metallized header is formed from a non-LDS injection molded polymer material. In one exemplary embodiment, the non-LDS injection molded polymer material comprises a high temperature thermoplastic (e.g., a liquid crystal polymer (LCP) and the like). The second portion 203 is formed from an injection molded polymer LDS material that is doped with a metal-plastic additive which is configured to be activated via the use of a laser.

After formation of the header using well-known injection molding techniques, the electronic circuitry 204 as well as the terminations 206 for the header apparatus is activated by means of a laser. The application of the electronic circuitry, as well as the terminations, is exemplary in that there are very few geometric restrictions for such a header design. As there are very few geometric restrictions, the underlying electronic circuitry can be located virtually anywhere on the three-dimensional surface of the metallized header 202. This electronic circuitry and plated terminations are created via the activation of the LDS polymer with a laser.

In the illustrated embodiment, a single electronic component receiving cavity 210 is integrally molded within the body of the first injection molded header portion 202. This cavity 210 is sized so as to accommodate a plurality of wound inductive devices. In one embodiment, and similar to that disclosed with respect to FIGS. 1A and 1B, a plurality of inductive devices comprised of windings and core elements, such as those disclosed in co-owned U.S. Pat. No. 7,598,839 to Wedley can readily be accommodated within this electronic component receiving cavity. The windings from these inductive devices are routed from the cavity 210 through a wire routing slot 212, and wrapped around a respective termination (not shown). The metallized header 200 also optionally includes an orientation notch (not shown) in the header that is indicative of where a specified pin location (e.g., pin one (1)) for subsequent mounting to a printed circuit board.

Referring now to the underside of the metallized header 200 and FIG. 2B, the electronic circuitry disposed on the second injection molded header portion 203 is illustrated. The illustrated electronic circuitry 204 is formed when the laser beam hits the metal additive present within the LDS polymer. The metal particles activated during this process form the nuclei for subsequent metallization processing steps. In one exemplary embodiment, this activated LDS polymer is submerged within an electroless copper bath. This electroless copper bath results in copper being deposited along the areas where the LDS polymer was activated via a laser. After being placed in the electroless copper bath, additional layers of, for example, copper, nickel and gold can be deposited onto these activated copper areas.

As is illustrated in FIG. 2B, the electronic circuitry 204 includes two (2) pairs of termination pads 208a, 208b that become mounting locations for surface mountable electronic components such as chip resistors, chip capacitors, chip inductors, etc. For example, these mounting locations can accommodate the surface mountable chip choke apparatus disclosed in co-owned and co-pending U.S. patent application Ser. No. 13/835,217 filed Mar. 15, 2013, the contents of which were previously incorporated herein by reference in their entirety. While a specific electronic circuitry topography is shown in FIG. 2B, any number of different electronic circuitry topographies can be readily substituted to accommodate any number of differing surface mountable electronic components or even electronic components (e.g. trace inductors or capacitors) manufactured from the deposited layers of conductive material itself. These and other variations would be readily apparent to one of ordinary skill given the present disclosure.

The underside of the metallized header 200 also includes a pair of standoff features 214 formed on the bottom portion of the first header apparatus 202. These standoff features provide a wash area underneath the metallized header 200 when inserted onto a printed circuit board so that corrosive chemicals (e.g., flux, etc.) left behind during the soldering operation that secures the metallized header to a printed circuit board can be removed. Also located within the second header portion 203 are ten (10) terminal receiving apertures 206. These apertures are sized so as to accept post-inserted (or insert-molded) through bole terminations (not shown) thus resulting in a through hole metallized header 200.

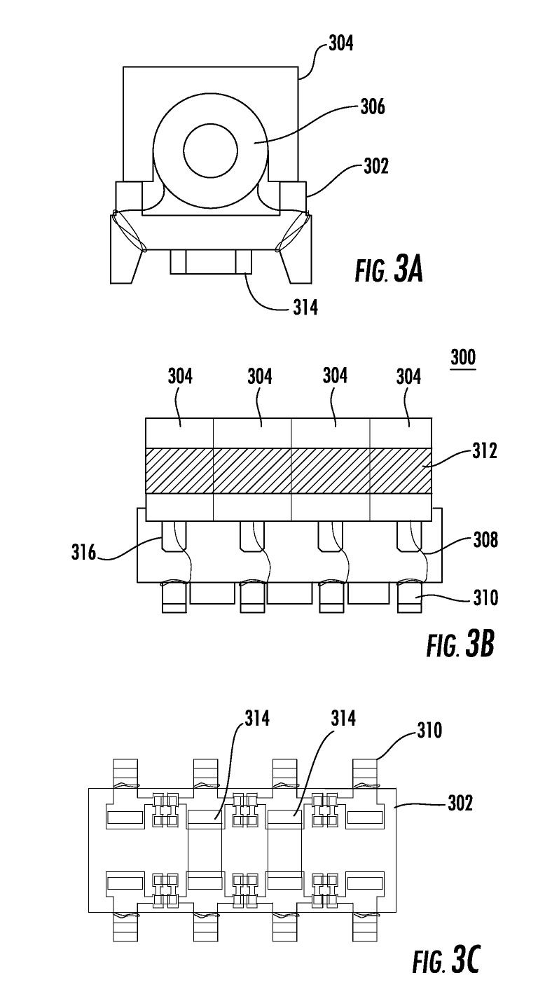

Referring now to FIG. 3, an exemplary embodiment of a metallized header electronics apparatus 300 is shown and described in detail. As shown, the embodiment of FIG. 3 includes the metallized header 302 having four (4) core portions 304, one or more windings 306 associated with each of the core portions and two (2) surface mountable electronic components 314. In an exemplary embodiment, each of the windings 306 will comprise form-less (i.e. bonded) windings, such as those disclosed in co-owned U.S. Pat. No. 7,598,839 to Wedley entitled “Stacked Inductive Device and Methods of Manufacturing”, the contents of which were previously incorporated herein by reference in its entirety. The ends of the formless windings 306 are routed through slots 316 and wrapped around terminals 310. In the embodiment illustrated, the terminals 310 comprise surface mountable terminals that are formed from the underlying injection-molded metallized header material.

The core portions 304 in the illustrated embodiment are what are referred to as “EP” cores. The open face of these “EP” style cores (i.e. the face in which the windings are placed within the core) is referred to as the front portion. These core portions are subsequently stacked either front-to-back, front-to-front or back-to-back with one another. It will be recognized that the placement of these core portions 304 can either be in the same orientation (e.g., all the core portions would be in either a front-to-back disposition, or in a front-to-front or back-to-back disposition in embodiments which only utilize two (2) core portions 304) or, alternatively, in a mixed orientation (e.g., in a front-to-back followed by a front-to-front, back-to-back, etc.). These and other variations would be readily apparent to one of ordinary skill given the present disclosure. The core portions are subsequently secured to the header via the use of an epoxy, adhesive or via mechanical means such as via a clamp (not shown). The core portions are also secured to one another in the illustrated embodiment via the use of a bonding tape 312 that is collectively wrapped around each of the core portions 304.

### Methods of Manufacture

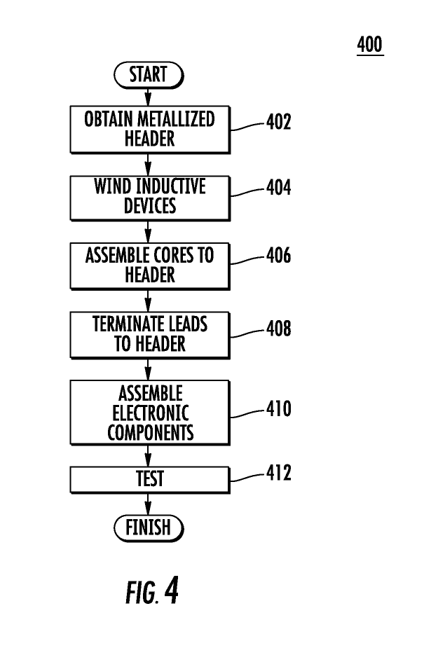

Referring now to FIG. 4, an exemplary embodiment of the method of manufacturing 400 the metallized header electronic apparatus 300 of, for example, FIG. 3 is shown and described in detail.

At step 402, the metallized header for use with the metallized header electronic apparatus is obtained. In one embodiment, the metallized header electronic apparatus is obtained from a third party vendor who has the manufacturing capabilities to injection mold the LDS polymer header, laser activate the plated portions and subsequently deposit the plating onto these laser activated portions. In an alternative embodiment, the manufacturer of the metallized header electronic apparatus also possesses the equipment to injection mold the LDS polymer header, laser activate the plated portions and subsequently deposit the plating onto these laser activated portions.

At step 404, the inductive devices are wound and subsequently placed within the core portions. In one embodiment, the use of form-less (bonded) windings is utilized such as that disclosed in co-owned U.S. Pat. No. 7,598,839 to Wedley entitled “Stacked Inductive Device and Methods of Manufacturing”, the contents of which were previously incorporated herein by reference in its entirety.

At step 406, the core portions are assembled to the metallized header obtained in step 402. In one embodiment, the core portions are secured to one another via the use of an epoxy, adhesive or via mechanical means such as via a clamp. In embodiments which utilize two (2) or more core portions, these cores can be assembled together prior to being bonded to the metallized header. Alternatively, these cores are assembled together as the cores are secured to the metallized header.

At step 408, the wire ends from the inductive device are terminated to the terminals of the metallized header. In one embodiment, the wire ends are routed through slots contained within the metallized header and subsequently wrapped around each of the terminals. The wire-wrapped terminals are then subsequently bonded to the terminals via hand soldering, solder dipping, resistance welding, conductive epoxies or any other known method for securing the wire ends to the terminals. In embodiments that utilize a eutectic solder, the wire-wrapped terminals can either be mass terminated via a wave solder or solder reflow process, or alternatively be manually terminated to the wire-wrapped terminals via a hand soldering operation.

At step 410, the electronic components that are to be secured to the electronic circuitry of the metallized header are assembled. In embodiments that utilize surface mount components, a eutectic solder paste is applied to the electronic circuitry of the metallized header and the electronic components are deposited using industry standard pick and place equipment and then placed in a solder reflow oven. In an alternative embodiment, the electronic components are secured to the electronic circuitry of the metallized header prior to the core portions and windings being attached to the metallized header, In yet another alternative embodiment which utilizes through-hole mounting technologies, the terminals of the electronic components are inserted through the metallized header and subsequently attached via the use of wave soldering, hand soldering, conductive epoxies and the like.

At step 412, the assembled metallized header electronic apparatus is optionally tested to ensure it meets the desired electrical performance parameters.

It will be recognized that while certain aspects of the present disclosure are described in terms of specific design examples, these descriptions are only illustrative of the broader methods of the disclosure, and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure described and claimed herein.

While the above detailed description has shown, described, and pointed out novel features of the present disclosure as applied to various embodiments, it will be understood that various omissions, substitutions, and changes in the form and details of the device or process illustrated may be made by those skilled in the art without departing from the principles of the present disclosure. The foregoing description is of the best mode presently contemplated of carrying out the present disclosure. This description is in no way meant to be limiting, but rather should be taken as illustrative of the general principles of the present disclosure. The scope of the present disclosure should be determined with reference to the claims.

1. A metallized header electronic apparatus for mounting onto the surface of a printed circuit board, comprising:
a header assembly having electronic circuitry disposed thereon;
one or more inductive devices housed within the header assembly, the one or more inductive devices each having one or more wire leads extending therefrom; and
one or more terminals associated with the header assembly, the one or more terminals having the one or more wire leads attached thereto.

2. The metallized header apparatus of claim 1, wherein the electronic circuitry has one or more electronic components mounted thereto.

3. The metallized header apparatus of claim 2, wherein the one or more electronic components comprise surface mountable electronic components.

4. The metallized header apparatus of claim 1, wherein the header assembly and the one or more terminals associated with the header assembly comprise a unitary construction.

5. The metallized header apparatus of claim 4, wherein the header assembly is formed from an injection molded polymer.

6. The metallized header apparatus of claim 5, wherein the injection molded polymer comprises a laser direct structuring (LDS) polymer.

7. The metallized header apparatus of claim 6, wherein the electronic circuitry disposed upon the header assembly comprises a plurality of termination pads.

8. The metallized header apparatus of claim 7, further comprising one or more surface mountable electronic components disposed onto the header assembly via the plurality of termination pads.

9. The metallized header apparatus of claim 5, wherein the electronic circuitry disposed upon the header assembly is disposed onto the header assembly using a conductive fluid deposition process.

10. The metallized header apparatus of claim 1, further comprising one or more magnetically permeable core elements.

11. The metallized header apparatus of claim 10, wherein the one or more inductive devices comprise formless inductive devices.

12. The metallized header apparatus of claim 11, wherein the one or more magnetically permeable core elements comprises a plurality of shaped core elements;
the plurality of shaped core elements collectively being disposed in both a front-to-front orientation and a front-to-back orientation.

13. The metallized header apparatus of claim 11, wherein the one or more terminals are configured for surface mounting the metallized header apparatus to an external printed circuit board.

14. The metallized header apparatus of claim 13, wherein the header assembly comprises one or more wire routing slots integrally formed therein.

15. A metallized header apparatus for mounting onto the surface of a printed circuit board, comprising:
a header assembly having electronic circuitry integrally disposed thereon; and
a plurality of terminals that are integrally formed with the header assembly.

16. The metallized header apparatus of claim 15, wherein the header assembly is formed from an injection molded polymer.

17. The metallized header apparatus of claim 16, wherein the injection molded polymer comprises a laser direct structuring (LDS) polymer.

18. The metallized header apparatus of claim 17, wherein the electronic circuitry disposed upon the header assembly comprises a plurality of termination pads.

19. The metallized header apparatus of claim 18, wherein the header assembly further comprises an electronic component receiving recess.

20. The metallized header apparatus of claim 19, wherein the header assembly comprises one or more wire routing slots integrally formed therein.
